(19) United States
(12) Patent Application Publication
(10) Pub. No.: US 2011/0074956 A1
(43) Pub. Date: Mar. 31, 2011

(54) DEVICE, CAMERA, AND METHOD FOR GENERATING IMAGES OF THE SURROUNDING OF A MOTOR VEHICLE

(76) Inventors: Petko Faber, Renningen (DE); Paul Ruhnau, Renningen (DE); Martin Rous, Renningen (DE)

(21) Appl. No.: 12/736,922

(22) PCT Filed: Nov. 28, 2008
(86) PCT No.: PCT/EP2008/066391

§ 371 Date: Nov. 22, 2010

(30) Foreign Application Priority Data
May 28, 2008 (DE) 10 2008 002 026.5

(51) Int. Cl. H04N 7/18

(52) U.S. Cl. 348/148; 348/E07.085

(57) ABSTRACT

A device for a motor vehicle (10) is provided, the device including a headlight (14) for illuminating surroundings of the motor vehicle (10) using light pulses and a camera (12) for generating images of the surroundings of the motor vehicle. The camera (12) and the headlight (14) are synchronized such that the camera (12) generates the images in dark phases (48) of the headlight (14). Furthermore, a camera and a method for generating images are provided.

### BACKGROUND OF THE INVENTION

1. Field of the Invention

The present invention relates to a device, a camera, and a method for generating images of the surroundings of a motor vehicle.

2. Description of Related Art

A method for regulating the light range and light direction of headlights in a motor vehicle is known from published European patent application document EP 0 869 031 A2, in which a camera surveys the road space in front of the motor vehicle along with the roadway and records image data. The course of the road is ascertained on the basis of the recorded image data, and the headlight aiming is adjusted accordingly. Furthermore, published European patent application document EP 0 869 031 A2 discloses that oncoming motor vehicles are detected and the illumination is regulated such that the oncoming motor vehicle does not experience a glare.

### SUMMARY OF THE INVENTION

In contrast, the device according to the present invention has the advantage of improving the detection of oncoming and preceding vehicles, as well as of other objects having active light sources. It is furthermore advantageous that measurement data may be ascertained from the generated images, which data are an index for the brightness of the surroundings. Because the images are generated in the dark phases of the headlight, the measurement of the brightness of the surroundings is not distorted by reflections of the host vehicle itself. The above may advantageously be used to detect an indirect illumination in towns, and thus to infer a traffic situation within a town and to switch off the high-beam headlights, since the use of high beams is prohibited by law within city limits. Thus, on the one hand, traffic safety is increased. On the other hand, this helps to ensure that legal requirements are met.

A synchronization connection between the camera and the headlight is advantageous, since this makes the synchronization particularly reliable and precise.

A camera is particularly advantageous that is designed such that the camera adjusts the recording times of the images as a function of the illumination of the surroundings of the motor vehicle by the headlights that is recorded in the images, such that the camera generates the images in the dark phases of the headlights. This eliminates the physical synchronization line. On the one hand, this helps reduce the cost of the device, and on the other hand, the cameras may be more simply combined with headlights since the camera itself performs the synchronization.

The dark phases are advantageously between one millisecond and five milliseconds, preferably four milliseconds, since a human being does not perceive dark phases selected in this manner. Instead, given suitably long bright phases, a human being perceives such light from the headlight as continual illumination.

The advantages mentioned for the device are correspondingly valid for the camera described below and the method according to the present invention.

Further advantages result from the subsequent description of exemplary embodiments with reference to the figures.

### BRIEF DESCRIPTION OF DRAWINGS

In the following, the present invention is elucidated in greater detail in light of the specific embodiment represented in the drawing.

FIG. 1 shows a motor vehicle.

FIG. 2 shows a block diagram of the first exemplary embodiment.

FIG. 3 shows a timing diagram of the first exemplary embodiment.

FIG. 4 shows a block diagram of the second exemplary embodiment.

FIG. 5 shows a block diagram of the third exemplary embodiment.

FIG. 6 shows a flow chart.

### DETAILED DESCRIPTION OF THE INVENTION

The following describes a device for a motor vehicle or a device in a motor vehicle, the device including a headlight for illuminating surroundings of the motor vehicle using light pulses and a camera for generating images of the surroundings of the motor vehicle. The camera and the headlight are synchronized such that the camera generates the images in dark phases of the headlight. Furthermore, a camera and a method for generating images are provided.

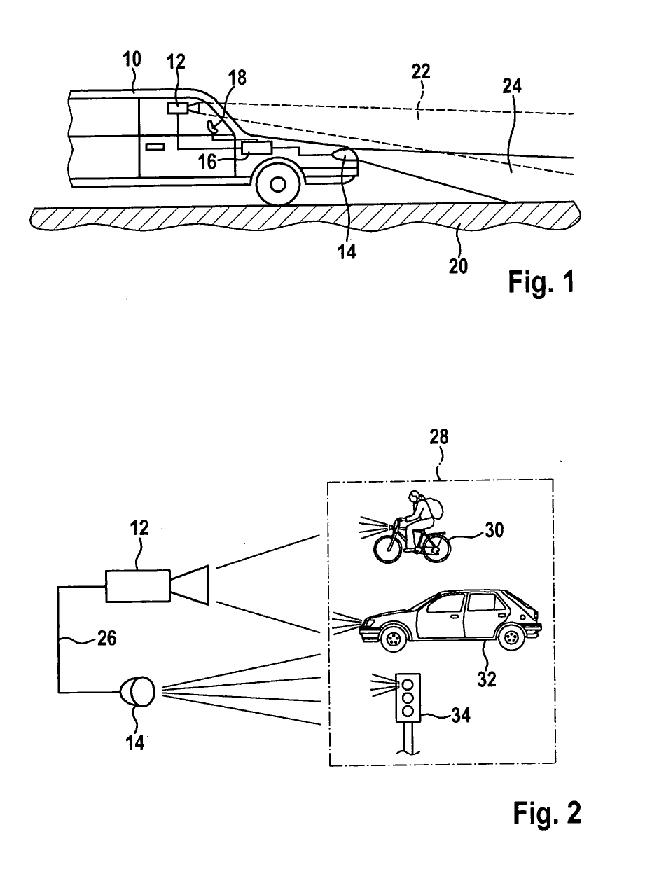

FIG. 1 shows a motor vehicle 10 on a roadway 20 of the exemplary embodiments. Motor vehicle 10 includes a camera 12 and a headlight 14. Both camera 12 and headlight 14 are connected to a control device 16. Camera 12 is installed in the region of the windshield and directed such that camera 12 records the surroundings in front of motor vehicle 10 with image recording region 22. In addition to a lens, camera 12 includes a CMOS image sensor or a CCD image sensor. A color camera is preferably used. Alternatively, a black-and-white camera is used. In the exemplary embodiments, a monoscopic camera, that is, an individual camera 12, is used. Alternatively, one variant provides for the use of a stereo camera. A stereo camera is distinguished by the fact that it includes at least two cameras that essentially record the same scene. Camera 12 records light in the wavelength range between 400 nm and 750 nm at least, preferably up to 1000 nm. In the exemplary embodiments, control device 16 ascertains measurement data from oncoming or preceding objects, motor vehicles in particular, from the images generated by camera 12. The images recorded by camera 12 in dark phases of headlights 14 are transmitted to control device 16 for this purpose. Control device 16 performs an image evaluation, in that the control device ascertains from the images active light sources in the surroundings. Preferably, control device 16 ascertains bright image regions and classifies these image regions as objects, in particular as headlights of oncoming motor vehicles and/or as tail lights of preceding motor vehicles and/or as light sources of cyclists and/or as traffic lights. Subsequently, control device 16 determines the position of the ascertained objects and transmits these measurement data to headlights 14. In one variant, control device 16 ascertains from the recorded images measurement data that are an index for the brightness of the surroundings. To this end, control device 16 calculates the average brightness of a recorded image or of a predetermined partial region of a recorded image. Control device 16 determines the traffic situation as a function of the ascertained brightness of the surroundings. In particular, control device 16 determines whether motor vehicle 10 is located within city limits, in that control device 16 compares the measurement value for the brightness of the surroundings with a threshold value, and infers a location within city limits if the threshold value is exceeded. Subsequently, control device 16 transmits a value that indicates whether a location within city limits was detected and a value for the brightness of the surroundings to headlights 14. As a function of the value that indicates a location within city limits, the high beam headlights of headlights 14 are deactivated if vehicle 10 is located within city limits. Headlights 14 are activated or deactivated as a function of the value for the brightness of the surroundings. To ensure the clarity of FIG. 1, only one single headlight 14 is drawn. Preferably, the exemplary embodiments use two headlights 14 that are disposed in the frontal region of motor vehicle 10 and illuminate the region in front of motor vehicle 10 with an illumination range 24. Headlights 14 are distinguished by the fact that they output pulsed light and thus illuminate the surroundings in front of motor vehicle 10 in a pulsed manner, the pulse frequency being selected in such a way that the human eye perceives the light of headlights 14 as a continual illumination. The headlights in the exemplary embodiments are preferably LED headlights or, alternatively, laser headlights. In the exemplary embodiments, the LED headlights on the right and left sides of motor vehicle 10 are respectively made up of a low beam module and an additional high beam module. The low beam module uses a plurality of multi-chip LEDs that generate white light in that the originally generated blue light is transformed into white light by a converter material. The light distribution of the low beam module is generated by reflectors and projection lenses. Multichip LEDs are also correspondingly used in conjunction with reflectors in the high beam module. Headlights 14 are designed such that the light width and additionally or alternatively the longitudinal light range of headlights 14 may be adjusted. Thus, headlights 14 are designed such that they provide both the function of the low beam light and the function of the high beam light. Moreover, headlights 14 are designed such that headlights 14 selectively illuminate selectable regions of the low beam light region and/or the high beam light region on the basis of the measurement data transmitted by control device 14, so that oncoming motor vehicles or preceding motor vehicles or cyclists are not blinded, but the region in front of motor vehicle 10 is nevertheless optimally illuminated. Furthermore, a display 18 is connected to control device 16. Control device 16 transmits to display 18 measurement data regarding recorded traffic lights. Display 18 is preferably an optical display. Alternatively or additionally, an acoustic display and/or a haptic display are provided. Preferably, the signaling (red, green, yellow, red-yellow) of the recorded traffic lights is displayed on the display and thus informs or also warns the driver of motor vehicle 10.

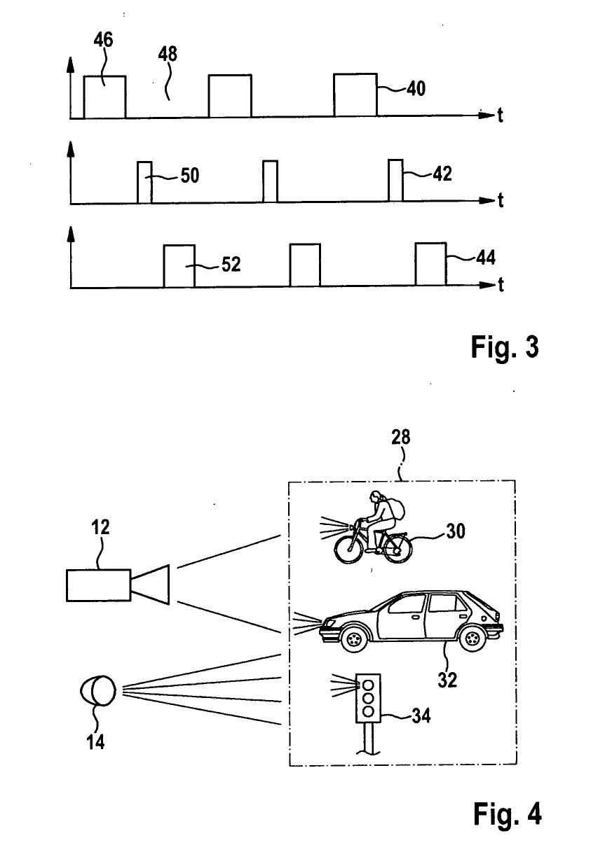

FIG. 2 shows a block diagram of the first exemplary embodiment, including one or a plurality of cameras 12 and one or a plurality of headlights 14, in contrast to FIG. 1, only those elements being shown that are necessary to explain the synchronization of camera 12 and headlight 14. As was already explained with regard to FIG. 1, headlight 14 illuminates surroundings 28 and camera 12 records at least one part of illuminated surroundings 28. In FIG. 2, a bicycle 30, a motorized road user 32, such as a car or a truck or a motorcycle, and a traffic light 34 are drawn in surroundings 28, by way of example. In the first exemplary embodiment, camera 12 and headlight 14 are synchronized via a synchronization connection 26 such that camera 12 generates the images in dark phases of headlight 14. Preferably, synchronization connection 26 is implemented as a wire-bound line, the wire-bound line being implemented either as a bus, a CAN bus, for example, or as a permanently assigned and connected line. Alternatively or additionally, synchronization connection 26 is implemented as a radio communication. The temporal synchronization is explained below with the aid of FIG. 3.

FIG. 3 shows a time diagram of the first exemplary embodiment in a schematic illustration. Time t is plotted on the x axis of the time diagram. The upper partial diagram shows time characteristic 40 of the illumination of the headlights. The headlights emit in periodic succession pulsed light having bright phases 46 and dark phases 48. In bright phases 46, the headlights output light into the surroundings, while the headlights do not output any light in dark phases 48. In bright phases 46, the headlights are thus switched on and there are switch-on phases of the headlights, while in dark phases 48, the headlights are switched off and there are thus switch-off phases of the headlights. In the first exemplary embodiment, but also in the additional exemplary embodiments, dark phase 48 is between 1 ms and 5 ms, preferably 4 ms. Preferably, dark phase 48 and bright phase 46 have a ratio of one to ten. Thus, bright phases 46 are ten times longer than dark phases 48. In one variant of the exemplary embodiments, one to ten dark phases 48 are generated per second by the headlight, preferably ten dark phases 48, having a duration between 1 ms and 5 ms, preferably 4 ms. Thus, dark phase 48 is selected such that a human being does not consciously perceive dark phases 48. The switching times of the headlights, in particular of the LED and laser headlights, from a bright phase 46 to a dark phase 48 or the other way around, are less than 0.1 ms in the exemplary embodiments. The switching times are preferably in the nanosecond range. The middle partial diagram illustrates time characteristic 42 of the synchronization signal on the synchronization connection between camera and headlights. In dark phases 48 the headlight generates a short synchronization pulse 50 that is transmitted from the headlight to the camera. As illustrated in the lower partial diagram that illustrates time characteristic 44 of the image capturing of the camera, the camera, triggered by synchronization pulse 50, performs an image capture 50 within dark phase 48 of the headlight illumination. In this variant of the first exemplary embodiment, the camera is thus designed such that the camera adjusts recording times of the images such that the camera generates the images in the dark phases 48 of the headlight. Thus, time characteristic 40 of the headlight illumination is predefined and time characteristic 44 of the image of the camera is variable and is synchronized with time characteristic 40 of the headlight illumination. Conversely, in one variant of the first exemplary embodiment, the headlight is triggered by a synchronization pulse 50 of the camera, in order to output a light pulse only if image capture 52 of the camera is complete. In this variant, synchronization pulse 50 is generated by the camera and the synchronization pulse is transmitted from the camera to the headlight. Thus, in this variant of the first exemplary embodiment, the headlight is designed such that the headlight adjusts the light pulses such that the camera generates images in the dark phases 48 of the headlight. Time characteristic 44 of the image capture of the camera is predefined and time characteristic 40 of the headlight illumination is variable and is synchronized with time characteristic 44 of the image capture.

FIG. 4 shows a block diagram of the second exemplary embodiment, including one or a plurality of cameras 12 and one or a plurality of headlights 14, in contrast to FIG. 1, only those elements being shown that are necessary to explain the synchronization of camera 12 and headlights 14. As already explained with regard to FIG. 1, headlight 14 illuminates surroundings 28 and camera 12 records at least one part of illuminated surroundings 28. A bicycle 30, a motorized road user 32, such as a car or a truck or a motorcycle, and a traffic light 34 are drawn in surroundings 28 in FIG. 4, by way of example. In the second exemplary embodiment, camera 12 and headlight 14 are not synchronized via a synchronization connection. Rather, camera 12 is designed such that camera 12 adjusts the recording times of the images as a function of the illumination of the surroundings of the motor vehicle by headlights 14 that is recorded in the images such that camera 12 generates the images in the dark phases of headlight 14. To this end, camera 12 captures a plurality of successive images, in that camera 12 records images of surroundings 28 of the motor vehicle. Depending on the offset between the time characteristic of the headlight illumination and the time characteristic of the image capturing, surroundings 28 are illuminated, intermittently illuminated, or not illuminated by headlights 14 during the capturing of an image. Subsequently, camera 12 determines for the individually recorded images whether headlight 14 was switched on, switched on for part of the time, or switched off during the image capturing. Camera 12 ascertains from this the time offset between the time characteristic of the headlight illumination and the time characteristic of the image capturing. On the basis of the time offset, camera 12 adjusts the recording times of the images such that camera 12 generates the images in the dark phases of headlight 14.

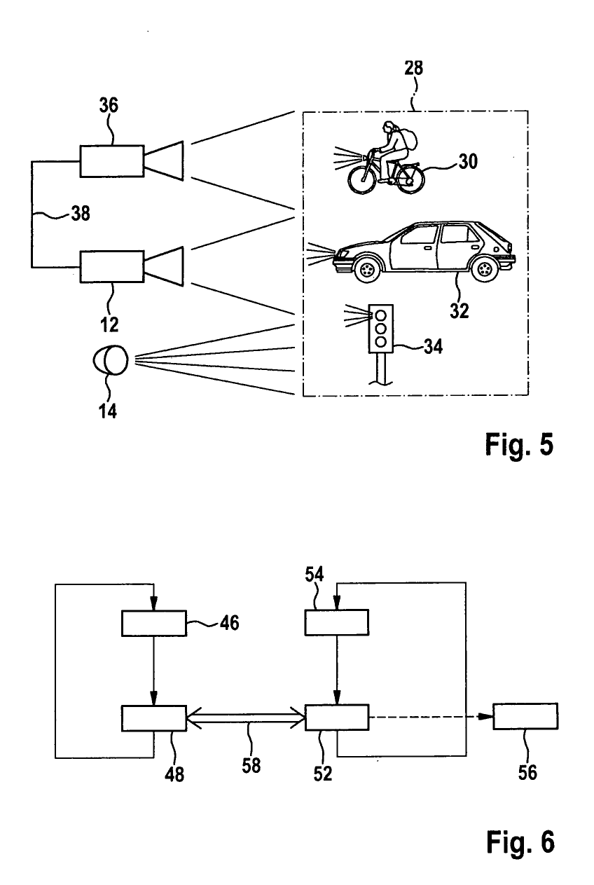

FIG. 5 shows a block diagram of the third exemplary embodiment, including one or a plurality of cameras 12 and one or a plurality of headlights 14, and at least one light sensor 36, in contrast to FIG. 1, only those elements being shown that are necessary to explain the synchronization of camera 12 and headlights 14. As was already explained with regard to FIG. 1, headlight 14 illuminates surroundings 28 and camera 12 records at least one part of illuminated surroundings 28. In FIG. 4, a bicycle 30, a motorized road user 32, such as a car or a truck or a motorcycle, and a traffic light 34 are drawn in surroundings 28, by way of example. In the third exemplary embodiment, camera 12 and headlight 14 are not synchronized via a synchronization connection. Instead, light sensor 36 detects the brightness in surroundings 28, in particular the light pulses of headlights 14 in surroundings 28. Light sensor 36 transmits the recorded brightness values to camera 12 via a line connection 38. Camera 12 is designed such that camera 12 adjusts the recording times of the images as a function of the light pulses of headlight 14 recorded by light sensor 36 such that camera 12 generates the images in the dark phases of headlight 14. To this end, camera 12 ascertains from the recorded brightness values of light sensor 36 the time characteristic of the headlight illumination. On this basis, camera 12 adjusts the recording times of the images such that camera 12 generates the images in the dark phases of headlight 14.

FIG. 6 shows a flow chart of the method. On the headlight side, dark phases 48 and bright phases 46 alternate in a periodically repeating manner. Accordingly, image captures 52 and periods without image captures 54 alternate in a periodically repeating manner as well. The camera and the headlights are synchronized with each other by a synchronization 58 such that the camera generates image captures 52 in dark phases 48 of the headlight. The images recorded in dark phases 48 of the headlight are optionally supplied to an image evaluation 56.

1-11. (canceled)

12. A device of a motor vehicle, comprising:
a headlight, the headlight illuminating surroundings of the motor vehicle using light pulses, and
a camera, the camera generating images of the surroundings of the motor vehicle,
wherein the camera and the headlight are synchronized such that the camera generates the images in dark phases of the headlight.

13. The device as recited in claim 12, which includes a synchronization connection between the camera and the headlight.

14. The device as recited in claim 13, wherein the synchronization connection is a synchronization line implemented as a bus connection.

15. The device as recited in claim 12, wherein the camera is designed such that the camera adjusts recording times of the images such that the camera generates the images in the dark phases of the headlight.

16. The device as recited in claim 13, wherein the camera is designed such that the camera adjusts recording times of the images such that the camera generates the images in the dark phases of the headlight.

17. The device as recited in claim 14, wherein the camera is designed such that the camera adjusts recording times of the images such that the camera generates the images in the dark phases of the headlight.

18. The device as recited in claim 12, wherein the headlight is designed such that the headlight adjusts the light pulses such that the camera generates the images in the dark phases of the headlight.

19. The device as recited in claim 13, wherein the headlight is designed such that the headlight adjusts the light pulses such that the camera generates the images in the dark phases of the headlight.

20. The device as recited in claim 14, wherein the headlight is designed such that the headlight adjusts the light pulses such that the camera generates the images in the dark phases of the headlight.

21. The device as recited in claim 12, wherein the camera is designed such that the camera adjusts the recording times of the images as a function of the illumination of the surroundings of the motor vehicle by the headlights that is recorded in the images such that camera generates the images in the dark phases of the headlights.

22. The device as recited in claim 12, which includes a light sensor, the light sensor recording the light pulses of the headlights, and the camera being designed such that the camera adjusts the recording times of the images as a function of the light pulses of the headlight that are recorded by the light sensor such that the camera generates the images in the dark phases of the headlight.

23. The device as recited in claim 12, which includes a control device that ascertains from the generated images measurement data of oncoming or preceding objects.

24. The device as recited in claim 23, wherein the objects are motor vehicles.

25. The device as recited in claim 13, wherein the objects are motor vehicles.

26. The device as recited in claim 12, which includes a control device that ascertains from the generated images measurement data that are an index for the brightness of the surroundings.

27. The device as recited in claim 13, which includes a control device that ascertains from the generated images measurement data that are an index for the brightness of the surroundings.

28. The device as recited in claim 12, wherein the headlights are designed such that at least one of a light width and a longitudinal light range of the headlights may be adjusted.

29. The device as recited in claim 13, wherein the headlights are designed such that at least one of a light width and a longitudinal light range of the headlights may be adjusted.

30. The device as recited in claim 12, wherein the dark phases are between one millisecond and five milliseconds long.

31. A camera of a motor vehicle, the camera generating images of the surroundings of the motor vehicle and being designed such that the camera is able to be synchronized with a headlight of the motor vehicle that outputs light pulses such that the camera generates images of the surroundings of the motor vehicle in dark phases of the headlight.

32. A method for generating images of surroundings of a motor vehicle via a camera, comprising illuminating the surroundings of the motor vehicle with light pulses using a headlight of the motor vehicle and synchronizing the camera and the headlight such that the camera generates images in dark phases of the headlight.
